(19) United States
(12) Patent Application Publication
(10) Pub. No.: US 2024/0420078 A1
(43) Pub. Date: Dec. 19, 2024

(54) Method, System, and Computer Program Product for Artificial Intelligence-Assisted Imaging and Inventory Management

(71) Applicant: Mobile Aspects, Inc., Pittsburgh, PA (US)

(72) Inventors: Muhammad R. Rahim, Monroeville, PA (US); Timur P. Sriharto, Monroeville, PA (US); Suneil Mandava, Pittsburgh, PA (US)

(21) Appl. No.: 18/740,057

(22) Filed: Jun. 11, 2024

Related U.S. Application Data
(60) Provisional application No. 63/508,079, filed on Jun. 14, 2023.

(51) Int. Cl. G06Q 10/087; G06T 7/20; G06V 10/764; G06V 20/52; G06V 40/10

(52) U.S. Cl. CPC G06Q 10/087; G06T 7/20; G06V 10/764; G06V 20/52; G06V 40/10; G06T 2207/20081; G06T 2207/30004; G06T 2207/30232; G06V 2201/034

(57) ABSTRACT

Described are a method, system, and computer program product for artificial intelligence-assisted imaging and inventory management. The method includes receiving image data from an imaging device of an item in a room of a hospital. The method also includes determining a location of the item based on a position of the imaging device. The method further includes inputting a portion of the image data to an image classification machine-learning model trained on a set of images of items associated with an inventory of the hospital. The method further includes determining an item identifier based on an output of the image classification machine-learning model. The method further includes determining an item record based on the item identifier and updating the item record. Updating the item record includes updating a last known location in the item record based on the location of the item.

### CROSS-REFERENCE TO RELATED APPLICATION

This application claims priority to U.S. Provisional Patent Application No. 63/508,079, filed Jun. 14, 2023, titled “Method, System, and Computer Program Product for Artificial Intelligence-Assisted Imaging and Inventory Management”, the disclosure of which is hereby incorporated by reference in its entirety.

### BACKGROUND

### 1. Technical Field

This disclosure relates generally to inventory management and, in non-limiting embodiments or aspects, to methods, systems, and computer program products for artificial intelligence-assisted imaging and inventory management.

### 2. Technical Considerations

Inventory management in hospitals is extremely difficult and complex. Many hospitals, including those with operating theater areas, may have poor knowledge and management of their inventory of items. This may be because items (e.g., supplies, implants, devices) are complex and variable, which may make them difficult to understand due to medical use, naming, and other related reasons. Additionally, items may vary in size, shape, coating, material, traits, and/or the like, for the same category of item, making it difficult to accurately keep an inventory of those items. Moreover, hospital personnel may prioritize their focus on the health and status of a patient (e.g., a patient undergoing a surgical operation) rather than an inventory, which may create opportunities for items to be misplaced, lost, or incorrectly documented. Such errors result in inaccurate inventories, where a true inventory of items does not match the documentation. This creates the danger of a needed item being unavailable when it is expected and needed for an important procedure. It also increases the risk of an item being inadvertently left somewhere it should not be (e.g., inside a patient, in a cleaning room, etc.).

Further to the above, hospitals may be required to document (e.g., for regulatory purposes) item implantation, including what implants were implanted into which patient, at what time, and by whom. Existing processes for implant documentation are prone to human error. Necessary information about an implanted item may be inadvertently omitted. Furthermore, existing inventory management solutions may require significant infrastructural changes to a hospital, such as attaching physical tracking devices to each individual item.

There is a need in the art for a technical solution to provide enhanced inventory management and cataloging of items in various areas of a hospital, including during and related to patient procedures. There is a further need in the art for such a technical solution to be low-impact on hospitals for requiring infrastructural and process changes.

### SUMMARY

Accordingly, provided are improved methods, systems, and computer program products for artificial intelligence-assisted imaging and inventory management.

According to non-limiting embodiments or aspects, provided is a computer-implemented method for artificial intelligence-assisted imaging and inventory management. The method includes receiving, with at least one processor, image data from at least one imaging device, the image data associated with at least one image of at least one item in at least one room of a hospital. The method also includes determining, with at least one processor, at least one location of the at least one item based at least partly on at least one position of the at least one imaging device. The method further includes inputting, with at least one processor, at least a portion of the image data to at least one image classification machine-learning model, the at least one image classification machine-learning model being trained at least partly on a set of images of items associated with an inventory of the hospital. The method further includes determining, with at least one processor, at least one item identifier of the at least one item based on at least one output of the at least one image classification machine-learning model. The method further includes determining, with at least one processor, at least one item record associated with the at least one item in at least one database based on the at least one item identifier. The method further includes updating, with at least one processor, the at least one item record in the at least one database. Updating the at least one item record includes updating at least one last known location in the at least one item record based on the at least one location of the at least one item.

In some non-limiting embodiments or aspects, the at least one item may be a plurality of items in the at least one room of the hospital, and the at least one item record may be a plurality of item records. The method may also include determining, with at least one processor, a plurality of locations of the plurality of items based on the plurality of item records. The method may further include generating, with at least one processor, an inventory report of the hospital based on the plurality of items and the plurality of locations.

In some non-limiting embodiments or aspects, determining the at least one item record in the at least one database may include determining that the at least one item record does not yet exist in the at least one database based on the at least one item identifier, and generating the at least one item record associated with the at least one item.

In some non-limiting embodiments or aspects, generating the at least one item record may include determining at least one expiration date associated with the at least one item, and updating at least one expiration date field of the at least one item record based on the at least one expiration date.

In some non-limiting embodiments or aspects, the method may include determining, with at least one processor, a plurality of expiration dates based on the plurality of item records. The method may also include determining, with at least one processor, a total value of the plurality of items based on an individual value of each item of the plurality of items. Generating the inventory report of the hospital may include generating the inventory report of the hospital based on the plurality of items, the plurality of locations, the plurality of expiration dates, and the total value.

In some non-limiting embodiments or aspects, the method may include determining, with at least one processor, at least one expired item based on a current date and the at least one expiration date field of the at least one item record. The method may also include transmitting, with at least one processor, at least one alert to at least one computing device associated with at least one inventory personnel based on the at least one expired item.

In some non-limiting embodiments or aspects, the method may include receiving, with at least one processor, a recall notice associated with the at least one item. The method may also include determining, with at least one processor, at least one current location of the at least one item based on the at least one item record. The method may further include transmitting, with at least one processor, at least one message to at least one computing device associated with at least one inventory personnel, the at least one message including the at least one current location of the at least one item and at least a portion of the recall notice.

In some non-limiting embodiments or aspects, receiving the image data from the at least one imaging device may include receiving the image data from the at least one imaging device on an ongoing basis, wherein the image data includes a stream of images. The method may include tracking, with at least one processor, the at least one item throughout the at least one room based on the stream of images.

In some non-limiting embodiments or aspects, the method may include determining, with at least one processor, at least one identification of at least one human in the at least one room based on the image data. Updating the at least one item record in the at least one database may include associating the at least one item record with at least one patient identifier or at least one clinician identifier based on the at least one identification of the at least one human.

In some non-limiting embodiments or aspects, the at least one human in the at least one room may be at least one patient undergoing at least one operation and at least one clinician performing the at least one operation. The method may include inputting, with at least one processor, at least a portion of the stream of images into the at least one image classification machine-learning model, the at least one image classification machine-learning model being trained at least partly on a set of images of actions taken in a plurality of patient operations. The method may also include determining, with at least one processor, at least one action of the at least one operation based on at least one second output of the at least one image classification machine-learning model. Updating the at least one item record in the at least one database may further include associating the at least one item record with the at least one patient identifier, the at least one clinician identifier, at least one identifier of the at least one action, and at least one time of the at least one action.

According to non-limiting embodiments or aspects, provided is a system for artificial intelligence-assisted imaging and inventory management. The system includes at least one processor. The at least one processor is configured to receive image data from at least one imaging device, the image data associated with at least one image of at least one item in at least one room of a hospital. The at least one processor is also configured to determine at least one location of the at least one item based at least partly on at least one position of the at least one imaging device. The at least one processor is further configured to input at least a portion of the image data to at least one image classification machine-learning model, the at least one image classification machine-learning model being trained at least partly on a set of images of items associated with an inventory of the hospital. The at least one processor is further configured to determine at least one item identifier of the at least one item based on at least one output of the at least one image classification machine-learning model. The at least one processor is further configured to determine at least one item record associated with the at least one item in at least one database based on the at least one item identifier. The at least one processor is further configured to update the at least one item record in the at least one database. When updating the at least one item record, the at least one processor is configured to update at least one last known location in the at least one item record based on the at least one location of the at least one item.

In some non-limiting embodiments or aspects, the at least one item may be a plurality of items in the at least one room of the hospital. The at least one item record may be a plurality of item records. The at least one processor may be further configured to determine a plurality of locations of the plurality of items based on the plurality of item records, and generate an inventory report of the hospital based on the plurality of items and the plurality of locations.

In some non-limiting embodiments or aspects, when determining the at least one item record in the at least one database, the at least one processor may be configured to determine that the at least one item record does not yet exist in the at least one database based on the at least one item identifier, and generate the at least one item record associated with the at least one item.

In some non-limiting embodiments or aspects, when receiving the image data from the at least one imaging device, the at least one processor may be configured to receive the image data from the at least one imaging device on an ongoing basis, wherein the image data includes a stream of images. The at least one processor may be further configured to track the at least one item throughout the at least one room based on the stream of images.

In some non-limiting embodiments or aspects, the at least one processor may be further configured to determine at least one identification of at least one human in the at least one room based on the image data. When updating the at least one item record in the at least one database, the at least one processor may be configured to associate the at least one item record with at least one patient identifier or at least one clinician identifier based on the at least one identification of the at least one human.

According to non-limiting embodiments or aspects, provided is a computer program product for artificial intelligence-assisted imaging and inventory management. The computer program product includes at least one non-transitory computer-readable medium including program instructions that, when executed by at least one processor, cause the at least one processor to receive image data from at least one imaging device, the image data associated with at least one image of at least one item in at least one room of a hospital. The program instructions also cause the at least one processor to determine at least one location of the at least one item based at least partly on at least one position of the at least one imaging device. The program instructions further cause the at least one processor to input at least a portion of the image data to at least one image classification machine-learning model, the at least one image classification machine-learning model being trained at least partly on a set of images of items associated with an inventory of the hospital. The program instructions further cause the at least one processor to determine at least one item identifier of the at least one item based on at least one output of the at least one image classification machine-learning model. The program instructions further cause the at least one processor to determine at least one item record associated with the at least one item in at least one database based on the at least one item identifier. The program instructions further cause the at least one processor to update the at least one item record in the at least one database. The program instructions that cause the at least one processor to update the at least one item record cause the at least one processor to update at least one last known location in the at least one item record based on the at least one location of the at least one item.

In some non-limiting embodiments or aspects, the at least one item may be a plurality of items in the at least one room of the hospital. The at least one item record may be a plurality of item records. The program instructions may further cause the at least one processor to determine a plurality of locations of the plurality of items based on the plurality of item records, and generate an inventory report of the hospital based on the plurality of items and the plurality of locations.

In some non-limiting embodiments or aspects, the program instructions that cause the at least one processor to determine the at least one item record in the at least one database may cause the at least one processor to determine that the at least one item record does not yet exist in the at least one database based on the at least one item identifier, and generate the at least one item record associated with the at least one item.

In some non-limiting embodiments or aspects, the program instructions that cause the at least one processor to receive the image data from the at least one imaging device may cause the at least one processor to receive the image data from the at least one imaging device on an ongoing basis, wherein the image data includes a stream of images. The program instructions may further cause the at least one processor to track the at least one item throughout the at least one room based on the stream of images.

In some non-limiting embodiments or aspects, the program instructions may further cause the at least one processor to determine at least one identification of at least one human in the at least one room based on the image data. The program instructions that cause the at least one processor to update the at least one item record in the at least one database may cause the at least one processor to associate the at least one item record with at least one patient identifier or at least one clinician identifier based on the at least one identification of the at least one human.

Further non-limiting embodiments or aspects are set forth in the following numbered clauses:
Clause 1: A computer-implemented method comprising: receiving, with at least one processor, image data from at least one imaging device, the image data associated with at least one image of at least one item in at least one room of a hospital; determining, with at least one processor, at least one location of the at least one item based at least partly on at least one position of the at least one imaging device; inputting, with at least one processor, at least a portion of the image data to at least one image classification machine-learning model, the at least one image classification machine-learning model being trained at least partly on a set of images of items associated with an inventory of the hospital; determining, with at least one processor, at least one item identifier of the at least one item based on at least one output of the at least one image classification machine-learning model; determining, with at least one processor, at least one item record associated with the at least one item in at least one database based on the at least one item identifier; and updating, with at least one processor, the at least one item record in the at least one database, wherein updating the at least one item record comprises: updating at least one last known location in the at least one item record based on the at least one location of the at least one item.
Clause 2: The computer-implemented method of clause 1, wherein the at least one item is a plurality of items in the at least one room of the hospital, and wherein the at least one item record is a plurality of item records, the method further comprising: determining, with at least one processor, a plurality of locations of the plurality of items based on the plurality of item records; and generating, with at least one processor, an inventory report of the hospital based on the plurality of items and the plurality of locations.
Clause 3: The computer-implemented method of clause 1 or clause 2, wherein determining the at least one item record in the at least one database comprises: determining that the at least one item record does not yet exist in the at least one database based on the at least one item identifier; and generating the at least one item record associated with the at least one item.
Clause 4: The computer-implemented method of any of clauses 1-3, wherein generating the at least one item record comprises: determining at least one expiration date associated with the at least one item; and updating at least one expiration date field of the at least one item record based on the at least one expiration date.
Clause 5: The computer-implemented method of any of clauses 1-4, wherein the method further comprises: determining, with at least one processor, a plurality of expiration dates based on the plurality of item records; and determining, with at least one processor, a total value of the plurality of items based on an individual value of each item of the plurality of items; and wherein generating the inventory report of the hospital comprises: generating the inventory report of the hospital based on the plurality of items, the plurality of locations, the plurality of expiration dates, and the total value.
Clause 6: The computer-implemented method of any of clauses 1-5, further comprising: determining, with at least one processor, at least one expired item based on a current date and the at least one expiration date field of the at least one item record; and transmitting, with at least one processor, at least one alert to at least one computing device associated with at least one inventory personnel based on the at least one expired item.
Clause 7: The computer-implemented method of any of clauses 1-6, further comprising: receiving, with at least one processor, a recall notice associated with the at least one item; determining, with at least one processor, at least one current location of the at least one item based on the at least one item record; and transmitting, with at least one processor, at least one message to at least one computing device associated with at least one inventory personnel, the at least one message comprising the at least one current location of the at least one item and at least a portion of the recall notice.
Clause 8: The computer-implemented method of any of clauses 1-7, wherein receiving the image data from the at least one imaging device comprises: receiving the image data from the at least one imaging device on an ongoing basis, wherein the image data comprises a stream of images; and wherein the method further comprises: tracking, with at least one processor, the at least one item throughout the at least one room based on the stream of images.
Clause 9: The computer-implemented method of any of clauses 1-8, further comprising: determining, with at least one processor, at least one identification of at least one human in the at least one room based on the image data; wherein updating the at least one item record in the at least one database further comprises: associating the at least one item record with at least one patient identifier or at least one clinician identifier based on the at least one identification of the at least one human.
Clause 10: The computer-implemented method of any of clauses 1-9, wherein the at least one human in the at least one room is at least one patient undergoing at least one operation and at least one clinician performing the at least one operation, the method further comprising: inputting, with at least one processor, at least a portion of the stream of images into the at least one image classification machine-learning model, the at least one image classification machine-learning model being trained at least partly on a set of images of actions taken in a plurality of patient operations; and determining, with at least one processor, at least one action of the at least one operation based on at least one second output of the at least one image classification machine-learning model; wherein updating the at least one item record in the at least one database further comprises: associating the at least one item record with the at least one patient identifier, the at least one clinician identifier, at least one identifier of the at least one action, and at least one time of the at least one action.
Clause 11: A system comprising: at least one processor configured to: receive image data from at least one imaging device, the image data associated with at least one image of at least one item in at least one room of a hospital; determine at least one location of the at least one item based at least partly on at least one position of the at least one imaging device; input at least a portion of the image data to at least one image classification machine-learning model, the at least one image classification machine-learning model being trained at least partly on a set of images of items associated with an inventory of the hospital; determine at least one item identifier of the at least one item based on at least one output of the at least one image classification machine-learning model; determine at least one item record associated with the at least one item in at least one database based on the at least one item identifier; and update the at least one item record in the at least one database, wherein, when updating the at least one item record, the at least one processor is configured to: update at least one last known location in the at least one item record based on the at least one location of the at least one item.
Clause 12: The system of clause 11, wherein the at least one item is a plurality of items in the at least one room of the hospital, wherein the at least one item record is a plurality of item records, and wherein the at least one processor is further configured to: determine a plurality of locations of the plurality of items based on the plurality of item records; and generate an inventory report of the hospital based on the plurality of items and the plurality of locations.
Clause 13: The system of clause 11 or clause 12, wherein, when determining the at least one item record in the at least one database, the at least one processor is configured to: determine that the at least one item record does not yet exist in the at least one database based on the at least one item identifier; and generate the at least one item record associated with the at least one item.
Clause 14: The system of any of clauses 11-13, wherein, when receiving the image data from the at least one imaging device, the at least one processor is configured to: receive the image data from the at least one imaging device on an ongoing basis, wherein the image data comprises a stream of images; and wherein the at least one processor is further configured to: track the at least one item throughout the at least one room based on the stream of images.
Clause 15: The system of any of clauses 11-14, wherein the at least one processor is further configured to: determine at least one identification of at least one human in the at least one room based on the image data; and wherein, when updating the at least one item record in the at least one database, the at least one processor is configured to: associate the at least one item record with at least one patient identifier or at least one clinician identifier based on the at least one identification of the at least one human.
Clause 16: A computer program product comprising at least one non-transitory computer-readable medium comprising program instructions that, when executed by at least one processor, cause the at least one processor to: receive image data from at least one imaging device, the image data associated with at least one image of at least one item in at least one room of a hospital; determine at least one location of the at least one item based at least partly on at least one position of the at least one imaging device; input at least a portion of the image data to at least one image classification machine-learning model, the at least one image classification machine-learning model being trained at least partly on a set of images of items associated with an inventory of the hospital; determine at least one item identifier of the at least one item based on at least one output of the at least one image classification machine-learning model; determine at least one item record associated with the at least one item in at least one database based on the at least one item identifier; and update the at least one item record in the at least one database, wherein the program instructions that cause the at least one processor to update the at least one item record cause the at least one processor to: update at least one last known location in the at least one item record based on the at least one location of the at least one item.
Clause 17: The computer program product of clause 16, wherein the at least one item is a plurality of items in the at least one room of the hospital, wherein the at least one item record is a plurality of item records, and wherein the program instructions further cause the at least at least one processor to: determine a plurality of locations of the plurality of items based on the plurality of item records; and generate an inventory report of the hospital based on the plurality of items and the plurality of locations.
Clause 18: The computer program product of clause 16 or clause 17, wherein the program instructions that cause the at least one processor to determine the at least one item record in the at least one database cause the at least one processor to: determine that the at least one item record does not yet exist in the at least one database based on the at least one item identifier; and generate the at least one item record associated with the at least one item.
Clause 19: The computer program product of any of clauses 16-18, wherein the program instructions that cause the at least one processor to receive the image data from the at least one imaging device cause the at least one processor to: receive the image data from the at least one imaging device on an ongoing basis, wherein the image data comprises a stream of images; and wherein the program instructions further cause the at least one processor to: track the at least one item throughout the at least one room based on the stream of images.
Clause 20: The computer program product of any of clauses 16-19, wherein the program instructions further cause the at least one processor to: determine at least one identification of at least one human in the at least one room based on the image data; and wherein the program instructions that cause the at least one processor to update the at least one item record in the at least one database cause the at least one processor to: associate the at least one item record with at least one patient identifier or at least one clinician identifier based on the at least one identification of the at least one human.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for artificial intelligence-assisted imaging and inventory management, according to some non-limiting embodiments or aspects;

FIG. 2 is a schematic diagram of example components of one or more devices of FIG. 1, according to some non-limiting embodiments or aspects;

FIG. 3 is a flow diagram of a method for artificial intelligence-assisted imaging and inventory management, according to some non-limiting embodiments or aspects;

FIG. 4A is an illustration of a first frame of a video showing a system for artificial intelligence-assisted imaging and inventory management, according to some non-limiting embodiments or aspects;

FIG. 4B is an illustration of a second frame of a video showing a system for artificial intelligence-assisted imaging and inventory management, according to some non-limiting embodiments or aspects;

FIG. 4C is an illustration of a third frame of a video showing a system for artificial intelligence-assisted imaging and inventory management, according to some non-limiting embodiments or aspects;

FIG. 4D is an illustration of a fourth frame of a video showing a system for artificial intelligence-assisted imaging and inventory management, according to some non-limiting embodiments or aspects;

FIG. 4E is an illustration of a fifth frame of a video showing a system for artificial intelligence-assisted imaging and inventory management, according to some non-limiting embodiments or aspects;

FIG. 4F is an illustration of a sixth frame of a video showing a system for artificial intelligence-assisted imaging and inventory management, according to some non-limiting embodiments or aspects;

FIG. 4G is an illustration of a seventh frame of a video showing a system for artificial intelligence-assisted imaging and inventory management, according to some non-limiting embodiments or aspects;

FIG. 4H is an illustration of an eighth frame of a video showing a system for artificial intelligence-assisted imaging and inventory management, according to some non-limiting embodiments or aspects; and

FIG. 4I is an illustration of a ninth frame of a video showing a system for artificial intelligence-assisted imaging and inventory management, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, desktop computers, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

The methods, systems, and computer program products described herein provide numerous technical advantages in systems for inventory management. For example, the described systems and methods more accurately identify items within an inventory, by using image data from imaging devices to determine identities of items. Image classification machine-learning models may be able to identify specific varieties or versions of items more quickly and accurately than inventory personnel. Moreover, by using image data to identify items, human error of identifying the wrong item or wrong version of an item would be reduced or eliminated. Described systems and methods further automatically identify the location of an imaged item based at least partly on a position of an imaging device, which increases the accuracy and potential granularity of documentation and record keeping. Human error of reporting item location is also mitigated, by eliminating users who misreport or misunderstand their location at the time of taking inventory. Furthermore, updating item records to reflect last known locations can be done substantially in real-time (e.g., immediately or substantially immediately, such that an action is taken in direct response to an event that is occurring at the time, such as on the scale of milliseconds, seconds, etc.) with the movement of items, since imaging devices can be placed in a fixed position in a room, and because the location and item identity can be determined substantially as soon as image data is generated. In this manner, items can be identified and tracked within and between rooms in real time, increasing the time relevance of inventory management. The above-described technical advantages may be particularly useful in a medical setting, where the location and use of an item may be urgent (e.g., time is of the essence), and the cost of erroneously taking inventory may be high (e.g., patient well-being and life is on the line).

Described systems and methods further provide the benefit of up-to-date, more accurate inventory reporting, by performing the item identification and location determination steps for a plurality of items in a hospital. In doing so, the described systems and methods can generate accurate and up-to-the-minute inventory reports of items within an entire room, unit, ward, and/or hospital. Furthermore, the inventory tracking steps may be combined with steps for mitigating risk of item expiration and recall. In non-limiting embodiments or aspects, the described systems and methods may provide substantially real-time expiration detection and recall notice reporting. Inventory personnel can be notified as soon as an item expires and immediately in response to a recall notice, to identify a problem item, the item's location, and even a replacement item for the problem item. This provides the technical advantage of maintaining an inventory of items that are usable and non-dangerous for employment in patient operations and procedures.

In non-limiting embodiments or aspects, the techniques for item recognition and tracking can be employed for human recognition and tracking. As such, the described systems and methods provide the technical benefit of identifying humans in a room, who may be patients, clinicians, inventory personnel, and/or the like. Moreover, the described systems and methods provide the benefit of up-to-date (e.g., real-time) documenting of user interaction with items, including which patients items were used for, which clinicians used the items, which inventory personnel moved or replaced items, and/or the like. This increases inventory accountability and information density, allowing for improved inventory analysis, tracking, and reporting.

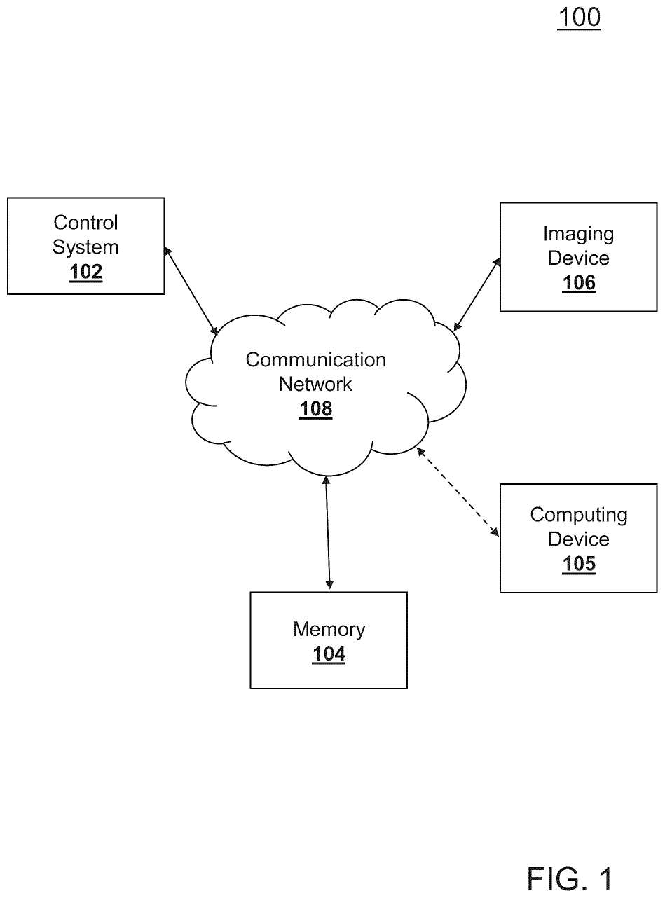

Referring now to FIG. 1, shown is a schematic diagram of a system 100 for artificial intelligence-assisted imaging and inventory management, according to some non-limiting embodiments or aspects. As shown in FIG. 1, system 100 may include control system 102, memory 104, computing device 105, imaging device 106, and communication network 108. Control system 102, memory 104, computing device 105, and imaging device 106 may interconnect (e.g., establish a connection to communicate) via wired connections, wireless connections, or a combination of wired and wireless connections.

Control system 102 may include one or more computing devices configured to communicate with memory 104, computing device 105, and/or imaging device 106 at least partly over communication network 108. Control system 102 may be configured to receive training data (e.g., training images) to train one or more image-classification machine-learning models, input new data (e.g., image data generated by imaging device 106) to image-classification machine-learning models, and receive output from image-classification machine-learning models based on the input of new data. Control system 102 may also be configured to receive image data from imaging device 106, detect and identify items and people within a room, track said items and people, and document the items and people over time. Control system 102 may include or be in communication with memory 104. Control system 102 may further be communicatively connected to an external notification system (e.g., a server associated with one or more manufacturers, regulatory bodies, government entities, etc.), to receive information about items that are being tracked (e.g., recall notices).

Memory 104 may include one or more computing devices configured to communicate with control system 102, computing device 105, and/or imaging device 106 at least partly over communication network 108. Memory 104 may be configured to data in one or more non-transitory computer readable storage media. For example, memory 104 may store image data generated by imaging device 106. Memory 104 may be configured to store at least one record (e.g., a data entry having multiple fields) associated with at least one item of an inventory of a hospital. Records stored in memory 104 may be updated (e.g., generated, added to, deleted from, modified, etc.) by control system 102. A record associated with an item and stored in memory 104 may include, but is not limited to, an item identifier, a location of the item, a time of last location update, a patient identifier, a patient procedure identifier (e.g., of a surgical operation), a clinician identifier (e.g., of a clinician, such as a doctor, nurse, or other medical staff), expiration date of item, cost/value of item (e.g., in dollars), and/or the like. Old records of items may be persisted in memory 104, and updates to a record may be maintained with a record as an appended table. Memory 104 may communicate with and/or be included in control system 102. Memory 104 may be further configured to store data of one or more image-classification machine learning models. Memory 104 may further be configured to store data of expiration dates or shelf-lives of items.

Computing device 105 may include one or more processors that are configured to communicate with control system 102, memory 104, and/or imaging device 106 at least partly over communication network 108. Computing device 105 may include one or more user interfaces for presenting data to a user and receiving input from a user. For example, computing device 105 may receive and at least partly display communications from control system 102 about one or more items in an inventory, such as a communication containing an inventory report, a communication notifying the user about a recall notice, a communication notifying the user about an expired item that needs to be replaced, and/or the like. In some non-limiting embodiments or aspects, computing device 105 may include imaging device 106.

Imaging device 106 may include one or more processors that are configured to communicate with control system 102, computing device 105, and/or memory 104 at least partly over communication network 108. Imaging device 106 may include at least one camera for generating image data (e.g., data associated with one or more images captured by at least one camera). The image data generated by imaging device 106 may be static (e.g., a picture) or dynamic (e.g., video). The image data may include a stream of images (e.g., a number of pictures taken over time, a video feed, etc.). In some non-limiting embodiments or aspects, imaging device 106 may be a mobile device. In some non-limiting embodiments or aspects, imaging device 106 may be a mounted camera on a wall or ceiling of a room of a hospital. System 100 may include one or more of imaging devices 106 distributed throughout one or more rooms of a hospital. In some non-limiting embodiments or aspects, imaging device 106 may be associated with or included in a same device as computing device 105.

Communication network 108 may include one or more wired and/or wireless networks over which the systems and devices of system 100 may communicate. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems and devices shown in FIG. 1 are provided as an example. There may be additional systems and/or devices, fewer systems and/or devices, different systems and/or devices, or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

In some non-limiting embodiments or aspects, control system 102 may perform one or more steps of a method for artificial intelligence-assisted imaging and inventory management. For example, control system 102 (e.g., a remotely operated computational cluster) may receive image data from at least one imaging device 106 (e.g., a camera mounted in a hospital room, a mobile device, etc.). The image data may be associated with at least one image (e.g., in a picture, from a video, etc.) of at least one item (e.g., a medical device, a tool, etc.) in at least one room (e.g., an operation theater, a storage room, a cleaning room, etc.) of a hospital (e.g., one or more buildings used to provide a medical service to a patient). Control system 102 may also determine at least one location (e.g., global positioning satellite (GPS) coordinates, a relative position, an absolute position, a room identifier, a container identifier, etc.) of the at least one item based at least partly on at least one position of the at least one imaging device 106 (e.g., physical position, angle of image capture, distance from target, etc.). For example, a location of the item may be set as the same location as the imaging device 106. By way of another example, a location of the item may be calculated based on a known location of the imaging device 106 in relation to a visual distance of the item from the imaging device 106.

In some non-limiting embodiments or aspects, control system 102 may input at least a portion of the image data to at least one image classification machine-learning model (e.g., configured for machine vision-based image recognition and classification prediction). The at least one image classification machine-learning model may be executed in and by control system 102. The at least one image classification machine-learning model may be trained (e.g., by control system 102, by model system, etc., in a prior time period) at least partly on a set of images of items associated with an inventory of the hospital. Control system 102 may then determine at least one item identifier (e.g., a code, a serial number, a tracking number, etc.) of the at least one item based on at least one output of the at least one image classification machine-learning model (e.g., a classification of the image as an item, a likelihood of an image being associated with a classification of item, etc.).

In some non-limiting embodiments or aspects, control system 102 may determine at least one item record (e.g., a log documenting at least location of an item) associated with the at least one item in at least one database (e.g., memory 104) based on the at least one item identifier. Control system 102 may then update the at least one item record in the at least one database. Updating the at least one item record may include updating at least one last known location (e.g., a last location field of the record) in the at least one item record based on the at least one location of the at least one item. Control system 102 may repeat the above processes for a plurality of items and a plurality of item records on an ongoing basis (e.g., repeatedly over time). Control system 102 may determine a plurality of locations of the plurality of items based on the plurality of item records and generate an inventory report (e.g., a message including a description or identifier of each item, a location of each item, a cost of each item, an expiration date of each item, a status of each item, a last patient associated with each item, a last user of each item, etc. and/or the like) of the hospital based on the plurality of items and the plurality of locations.

In some non-limiting embodiments or aspects, control system 102 may, when determining the at least one item record in the at least one database, determine that the at least one item record does not yet exist. Accordingly, control system 102 may generate the at least one item record associated with the at least one item, which may be triggered by the identification of an item that does not yet have a record. When generating the at least one item record, control system 102 may determine at least one expiration date associated with the at least one item (e.g., from memory 104, from a regulatory body database, etc.). Control system 102 may then update at least one expiration date field of the at least one item record based on the at least one expiration date.

In some non-limiting embodiments or aspects, control system 102 may determine a plurality of expiration dates based on the plurality of item records (e.g., an expiration date field of each item record of the plurality of item records). Control system 102 may also determine a total value (e.g., in dollars) of the plurality of items based on an individual value (e.g., as determined from a value field of an item record) of each item of the plurality of items (e.g., representative of a purchase cost, replacement cost, resale cost, etc.). When generating the inventory report of the hospital, control system 102 may generate the inventory report based on the plurality of items (e.g., listing each item on a separate line), the plurality of locations (e.g., listing a last known location of each item in the line for each item), the plurality of expiration dates (e.g., listing an expiration date of each item in the line for each item), and the total value (e.g., listing a value next to each item and/or a total value listed in the inventory report).

In some non-limiting embodiments or aspects, control system 102 may determine at least one expired item based on a current date and the at least one expiration date field of the at least one item record (e.g., by comparing the current date to the expiration date of each item record of the at least one item record). In response to determining at least one expired item, control system 102 may transmit at least one alert to at least one computing device 105 (e.g., a computing device associated with at least one inventory personnel, such as a mobile device of a stocking employee) based on the at least one expired item. For example, the alert may include a message describing the at least one expired item, a location of the at least one expired item, and/or the location of an item of the same type as the at least one expired item, which the inventory personnel can obtain to replace the at least one expired item. By way of further example, in response to determining the at least one expired item, control system 102 may transmit a request for a replacement item of the same type as the at least one expired item to another storage facility or hospital that possesses the replacement item.

In some non-limiting embodiments or aspects, control system 102 may receive a recall notice (e.g., a message from a regulatory body, a manufacturer of the item, etc., indicating an item identifier, a recall notice identifier, a description of the reason for the recall, a replacement item identifier, etc.) associated with the at least one item. In response to receiving the recall notice, control system 102 may determine at least one current location (e.g., a storage container, a shelf, a room, a hospital, and/or the like) of the at least one item based on the at least one item record (e.g., a location field of the item record). Control system 102 may then transmit at least one message to at least one computing device 105 associated with at least one inventory personnel (e.g., a mobile device of a stocking employee) including the at least one current location of the at least one item and at least a portion of the recall notice (e.g., an item identifier, a recall notice identifier, a description of the reason for the recall, a replacement item identifier, etc.).

In some non-limiting embodiments or aspects, when receiving the image data from at least one imaging device 106, control system 102 may receive the image data from at least one imaging device 106 on an ongoing basis (e.g., repeatedly receiving data over time), wherein the image data comprises a stream of images (e.g., a plurality of pictures, a video data stream, etc.). Control system 102 may further track the at least one item throughout the at least one room (e.g., as the item moves, is moved, is carried, etc.) based on the stream of images (e.g., using image-tracking machine vision). Control system 102 may track an item from one location in a room to another, and/or from one room to another, and may update an item record of the item as the item is tracked and moved between locations. It will also be appreciated that the image data may be used to identify humans in one or more rooms. For example, control system 102 may determine at least one identification of at least one human (e.g., a patient identifier, a clinician identifier, a staff identifier, a name, etc.) based on the image data (e.g., using facial recognition, by reading a barcode, etc.). When updating the at least one item record in the at least one database, control system 102 may associate the at least one item record with at least one patient identifier or at least one clinician identifier based on the at least one identification of the at least one human.

In some non-limiting embodiments or aspects, the at least one human in the room may be at least one patient undergoing at least one operation (e.g., surgery, scan, evaluation, etc.) and at least one clinician performing the at least one operation. Control system 102 may further input at least a portion of the stream of images (e.g., one or more image, sequences of images, or portions of image data) into at least one image classification machine-learning model that is trained at least partly on a set of images of actions taken in a plurality of patient operations (e.g., images of movements of humans and/or objects to carry out an operation, such as a doctor making an incision, an anesthetist applying a mask, a nurse starting an intravenous port, etc.). Control system 102 may then determine at least one action of the at least one operation (e.g., that is being performed in the room being monitored by imaging device 106) based on at least one second output (e.g., separate from an output used to identify the item) of the at least one image classification machine-learning model (e.g., a classification of an action). When updating the at least one item record in the at least one database, control system 102 may associate the at least one item record with the at least one patient identifier, the at least one clinician identifier, at least one identifier of the at least one action (e.g., based on the output of the image classification machine-learning model), and/or at least one time of the at least one action (e.g., based on a time associated with the receipt or sending of the stream of images from imaging device 106).

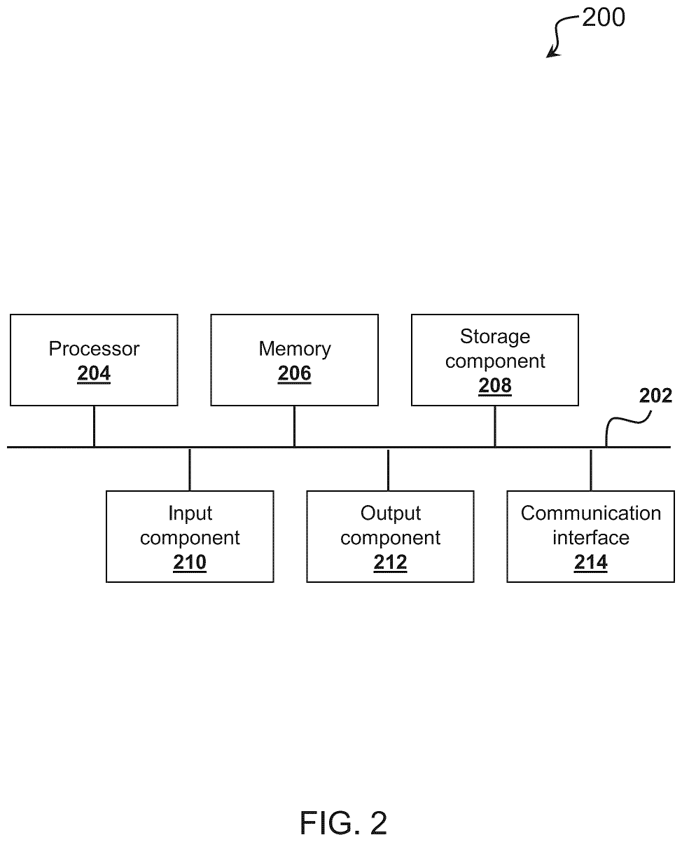

Referring now to FIG. 2, shown is a diagram of example components of a device 200, according to non-limiting embodiments. Device 200 may correspond to one or more devices of control system 102, memory 104, computing device 105, imaging device 106, and/or communication network 108, as an example. In some non-limiting embodiments, such systems or devices may include at least one device 200 and/or at least one component of device 200. The number and arrangement of components shown are provided as an example. In some non-limiting embodiments, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

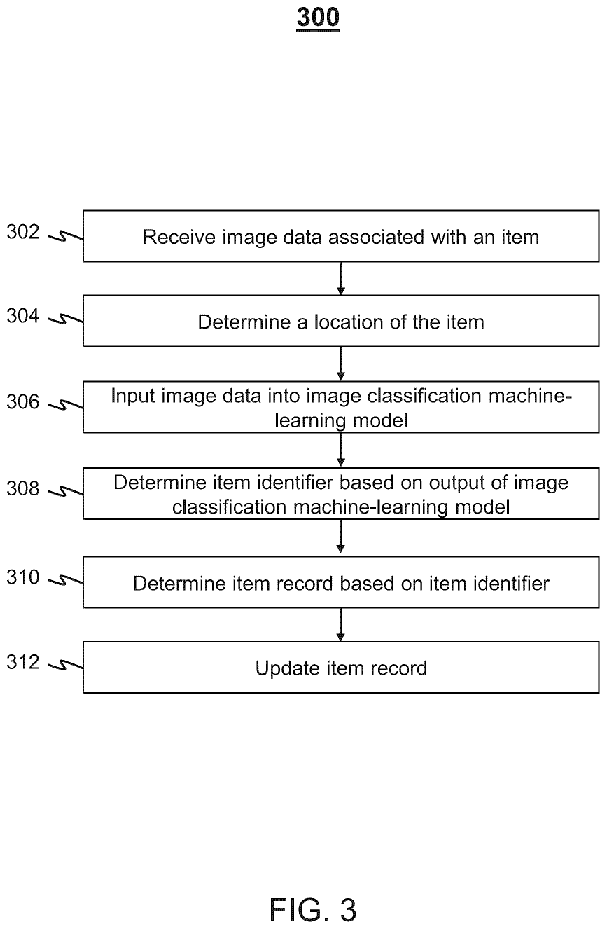

Referring now to FIG. 3, shown is a flow diagram for a method for artificial intelligence-assisted imaging and inventory management, according to some non-limiting embodiments or aspects. The steps shown in FIG. 3 are for example purposes only. It will be appreciated that additional, fewer, different, and/or a different order of steps may be used in non-limiting embodiments or aspects. In some non-limiting embodiments or aspects, a step may be automatically performed in response to performance and/or completion of a prior step. In some non-limiting embodiments or aspects, one or more of the steps of process 300 may be performed (e.g., completely, partially, and/or the like) by control system 102. In some non-limiting embodiments or aspects, one or more of the steps of process 300 may be performed (e.g., completely, partially, and/or the like) by another system, another device, another group of systems, or another group of devices, separate from or including control system 102.

As shown in FIG. 3, at step 302, process 300 may include receiving image data associated with an item. For example, control system 102 may receive image data from at least one imaging device 106, the image data associated with at least one image of at least one item in at least one room of a hospital. In some non-limiting embodiments or aspects, the at least one item may be a plurality of items in the at least one room of the hospital, and the at least one item record may be a plurality of item records. In some non-limiting embodiments or aspects, when receiving the image data from the at least one imaging device 106 (at step 302), control system 102 may receive the image data from the at least one imaging device 106 on an ongoing basis, and the image data may include a stream of images. Control system 102 may further track the at least one item throughout the at least one room based on the stream of images.

As shown in FIG. 3, at step 304, process 300 may include determining a location of the item. For example, control system 102 may determine at least one location of the at least one item based at least partly on at least one position of the at least one imaging device. In some non-limiting embodiments or aspects, control system 102 may further determine at least one identification of at least one human in at least one room based on the image data (at step 304). The at least one human may be at least one patient undergoing at least one operation and at least one clinician performing the at least one operation. Control system 102 may determine the at least one identification of the at least one human by inputting at least a portion of the image data into at least one image classification machine-learning model, wherein the at least one image classification machine-learning model is trained at least partly on a set of images of actions taken in a plurality of patient operations. Control system 102 may then determine at least one action of the at least one operation based on at least one second output of the at least one image classification machine-learning model.

As shown in FIG. 3, at step 306, process 300 may include inputting the image data into an image classification machine-learning model. For example, control system 102 may input at least a portion of the image data to at least one image classification machine-learning model. The at least one image classification machine-learning model may be trained at least partly on a set of images of items associated with an inventory of the hospital.

As shown in FIG. 3, at step 308, process 300 may include determining an item identifier based on an output of the image classification machine-learning model. For example, control system 102 may determine at least one item identifier of the at least one item based on at least one output of the at least one image classification machine-learning model.

As shown in FIG. 3, at step 310, process 300 may include determining an item record based on the item identifier. For example, control system 102 may determine at least one item record associated with the at least one item in at least one database (e.g., memory 104) based on the at least one item identifier.

In some non-limiting embodiments or aspects, when determining an item record (at step 310), control system 102 may determine that the at least one item record does not yet exist in the at least one database (e.g., memory 104) based on the at least one item identifier. In response to determining that the at least one item record does not yet exist, control system 102 may generate the at least one item record associated with the at least one item. When generating the at least one item record, control system 102 may determine at least one expiration date associated with the at least one item, and update at least one expiration date field of the at least one item record based on the at least one expiration date.

In some non-limiting embodiments or aspects, control system 102 may determine a plurality of locations of a plurality of items based on a plurality of item records. Control system 102 may generate an inventory report of the hospital based on the plurality of items and the plurality of locations. Control system 102 may determine a plurality of expiration dates based on the plurality of item records, and include the plurality of expiration dates in the generated inventory report. Control system 102 may also determine a total value of the plurality of items based on an individual value of each item of the plurality of items and include the total value in the generated inventory report.

In some non-limiting embodiments or aspects, control system 102 may determine at least one expired item based on a current date and the at least one expiration date field of the at least one item record, and transmit at least one alert to at least one computing device 105 associated with at least one inventory personnel based on the at least one expired item.

As shown in FIG. 3, at step 312, process 300 may include updating the item record. For example, control system 102 may update the at least one item record in the at least one database (e.g., memory 104). Updating the at least one item record may include updating at least one last known location in the at least one item record based on the at least one location of the at least one item.

In some non-limiting embodiments or aspects, control system 102 may update (at step 312) the at least one item record by associating the at least one item record with at least one patient identifier or at least one clinician identifier based on the at least one identification of at least one human (at step 304). When updating the at least one item record (at step 312), control system 102 may further associate the at least one item record with at least one patient identifier, at least one clinician identifier, at least one identifier of at least one action performed in an operation, and at least one time of the at least one action.

In some non-limiting embodiments or aspects, control system 102 may receive a recall notice associated with the at least one item. Control system 102 may determine at least one current location of the at least one item based on the at least one item record, and transmit at least one message to at least one computing device 105 associated with at least one inventory personnel. The at least one message may include the at least one current location of the at least one item and at least a portion of the recall notice.

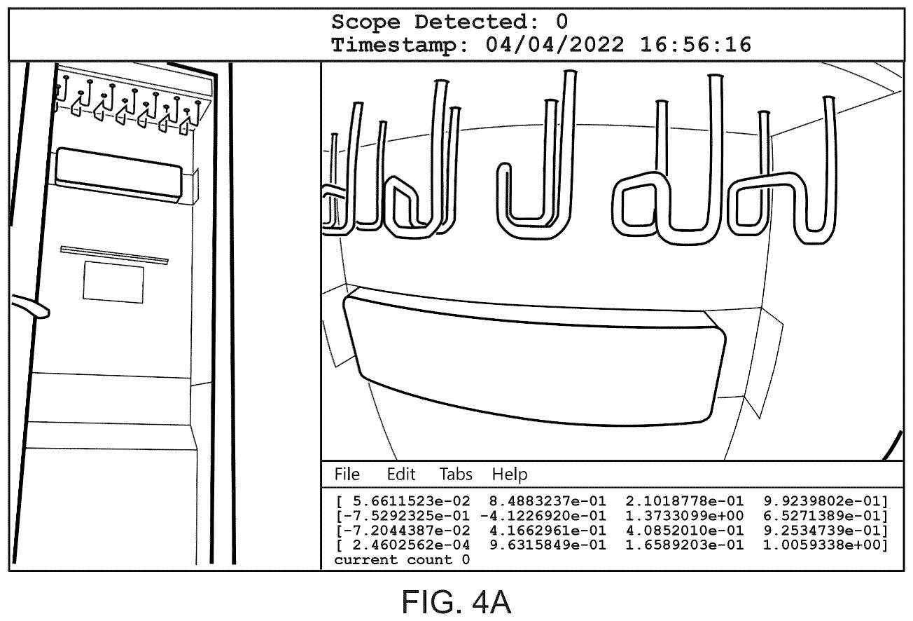

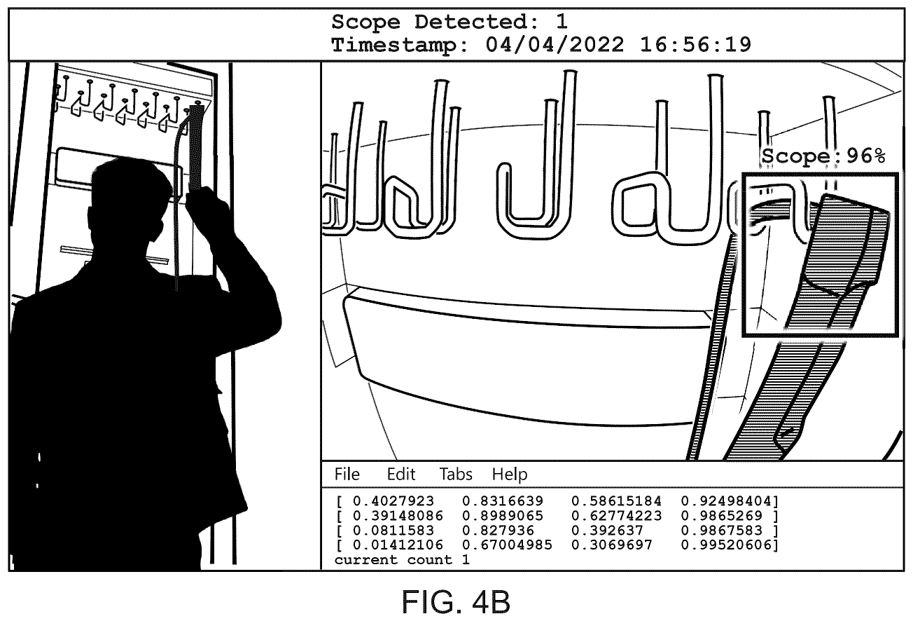

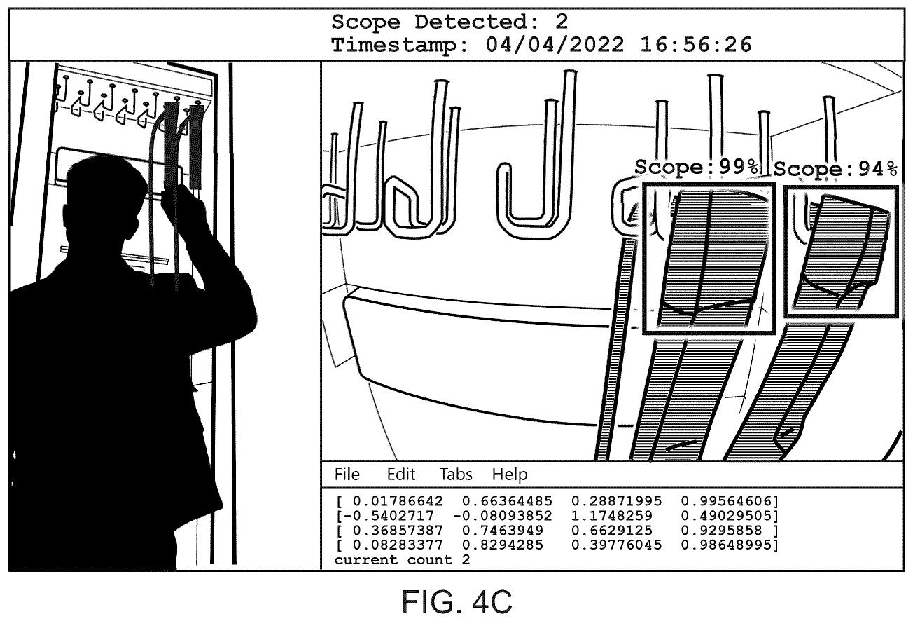

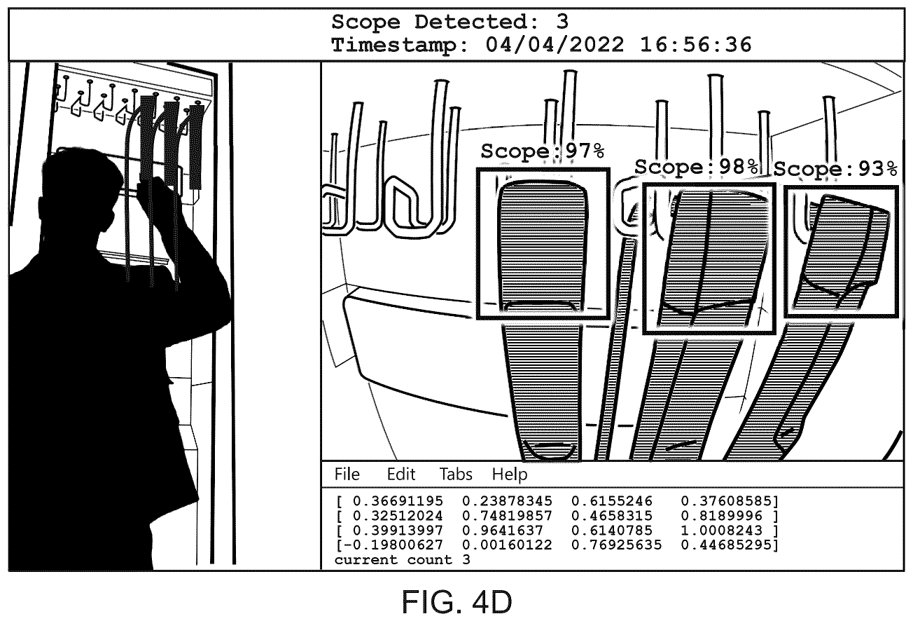

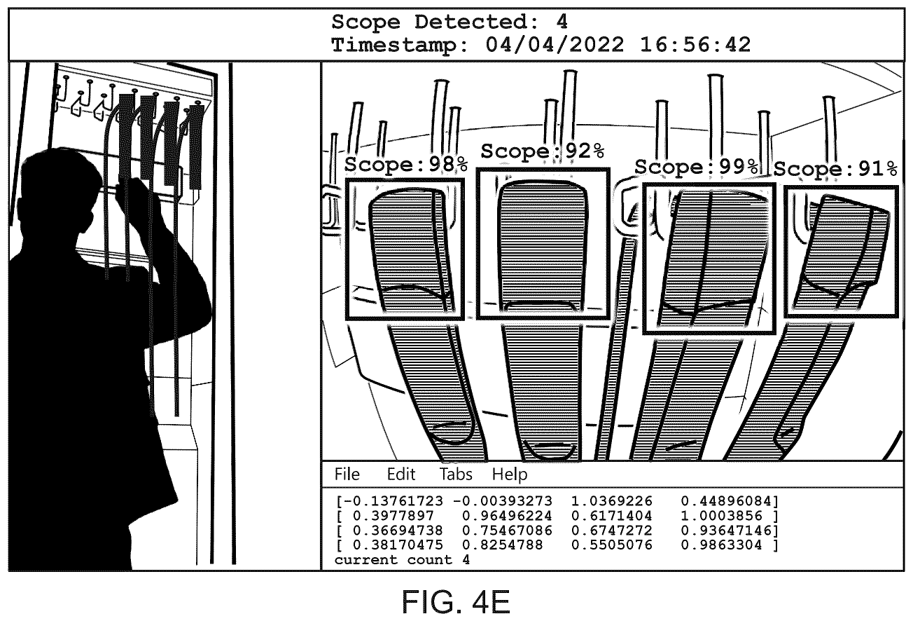

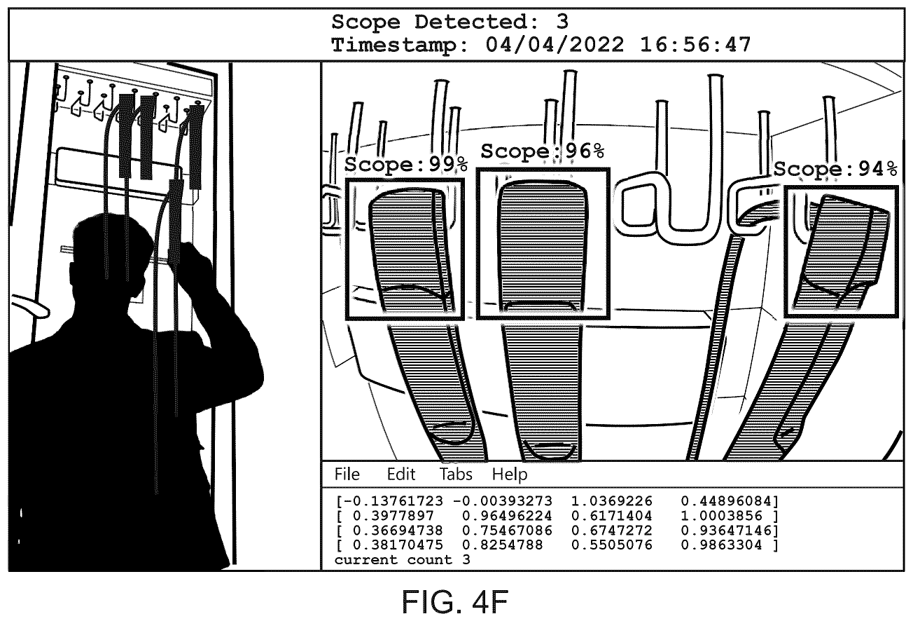

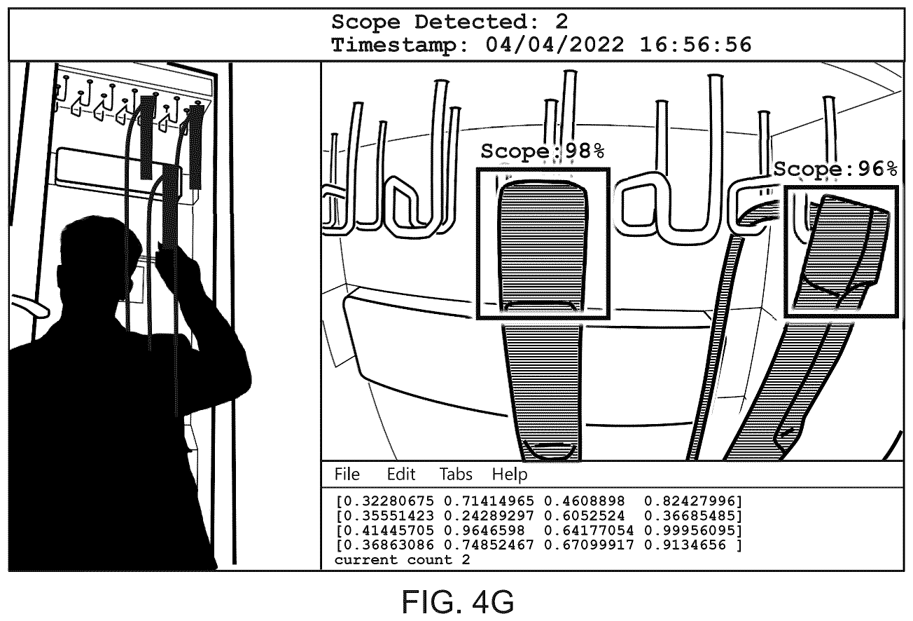

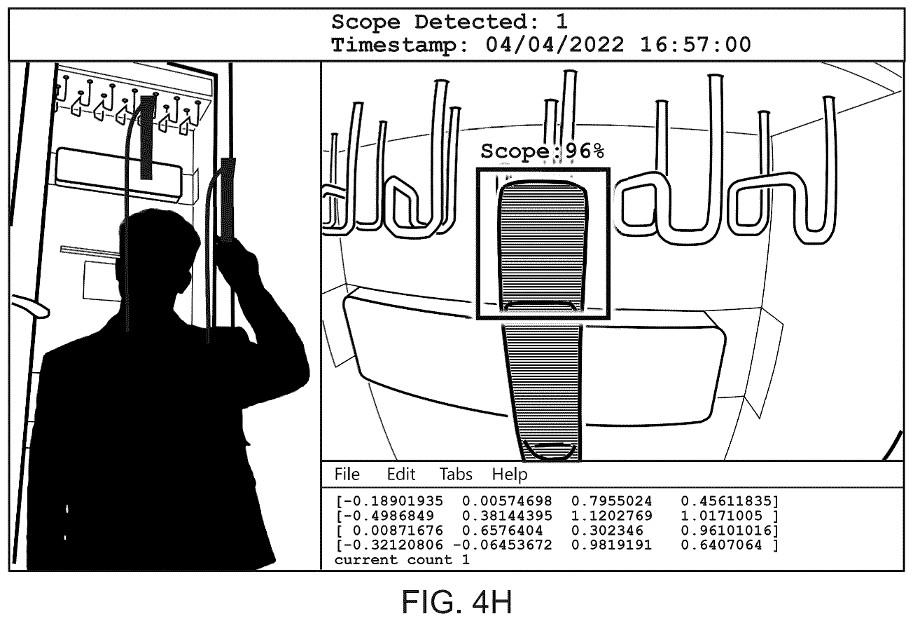

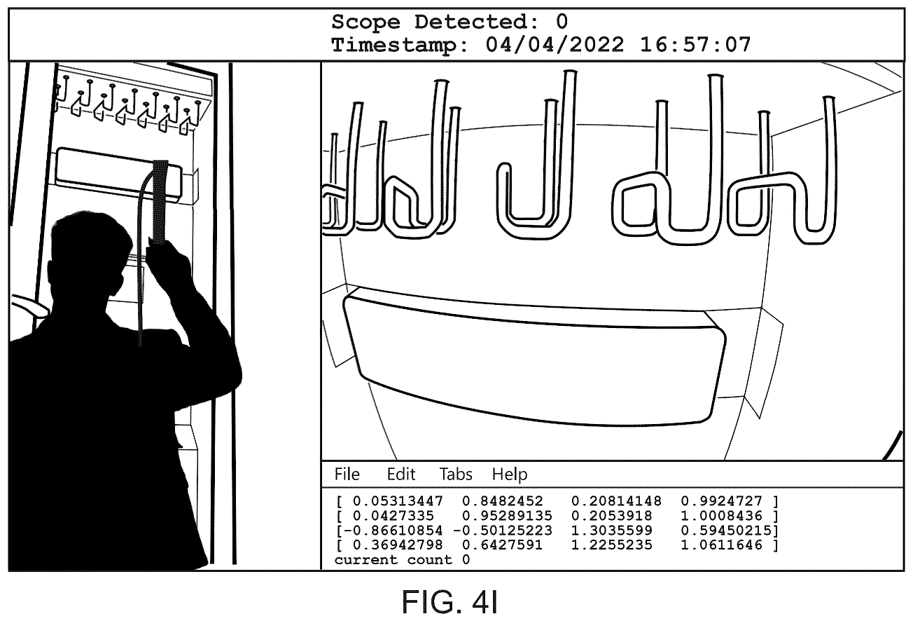

Referring now to FIGS. 4A-4I, FIGS. 4A-4I are a series of illustrations of frames from a video showing a system for artificial intelligence-assisted imaging and inventory management, according to some non-limiting embodiments or aspects. The system depicted in the frames of FIGS. 4A-4I is shown for example purposes only. In each frame of FIGS. 4A-4I, there is a first subframe on the left side depicting a wider perspective of a storage cabinet that may be used to store endoscopes, a second subframe on the right side depicting a close-up perspective of an interior of the storage cabinet, a third subframe on the bottom-right side depicting a software readout of control system 102 that is monitoring items within the storage cabinet, and a fourth subframe on the top banner depicting scope count and video time stamp. The image of the first subframe may be produced by a first imaging device 106, and the image of the second subframe may be produced by a second imaging device 106. The fourth subframe contains a first line of text that is associated with an output of control system 102, which depicts the number of items (e.g., scopes) detected by control system 102, and a second line of text associated with a time stamp of the video feed in month, day, year, hour, minute, second format. The second subframe focuses on four mounting positions (e.g., hooks acting as locations where items can be stored) within storage cabinet. The illustrated system may capture and/or analyze video frames at a much faster rate than shown (e.g., 10 frames per second, 20 frames per second, etc.), and the selected illustrated frames are provided to show changes in the system due to the addition or removal of stored items.

As shown in FIG. 4A, depicted is a first frame of the video showing the system at a first time stamp. At the first time stamp, the storage cabinet is empty. As such, control system 102 receives image data associated with the interior of the storage cabinet and determines, based at least partly on an image classification machine-learning model, that there is no item present, and, therefore, no location at which an item is being stored. The first line of text in the fourth subframe reflects that the number of items detected is zero.

As shown in FIG. 4B, depicted is a second frame of the video showing the system at a second time stamp. Three seconds have passed since the first time stamp of the first frame. At the second time stamp, a user has inserted a first item (e.g., an endoscope) onto a first mounting position of the storage cabinet. Control system 102 receives image data associated with the interior of the storage cabinet and, based at least partly on an image classification machine-learning model, determines that there is one item present and generates a classification of the detected item. At the second time stamp, control system 102 asserts a 96% likelihood that the item stored in the first position is a “scope.” The first line of text in the fourth subframe reflects that the number of items detected is 1.

As shown in FIG. 4C, depicted is a third frame of the video showing the system at a third time stamp. Seven seconds have passed since the second time stamp of the second frame. At the third time stamp, a user has inserted a second item (e.g., an endoscope) onto a second mounting position of the storage cabinet. Control system 102 receives image data associated with the interior of the storage cabinet and, based at least partly on an image classification machine-learning model, determines that there are two items present and generates a classification of the detected items. At the third time stamp, control system 102 asserts a 99% likelihood that the item stored in the second position is a “scope”, and a 94% likelihood that the item stored in the first position is a “scope.” The first line of text in the fourth subframe reflects that the number of items detected is 2.

As shown in FIG. 4D, depicted is a fourth frame of the video showing the system at a fourth time stamp. Ten seconds have passed since the third time stamp of the third frame. At the fourth time stamp, a user has inserted a third item (e.g., an endoscope) onto a third mounting position of the storage cabinet. Control system 102 receives image data associated with the interior of the storage cabinet and, based at least partly on an image classification machine-learning model, determines that there are three items present and generates a classification of the detected items. At the fourth time stamp, control system 102 asserts a 97% likelihood that the item stored in the third position is a “scope”, a 98% likelihood that the item stored in the second position is a “scope”, and a 93% likelihood that the item stored in the first position is a “scope.” The first line of text in the fourth subframe reflects that the number of items detected is 3.

As shown in FIG. 4E, depicted is a fifth frame of the video showing the system at a fifth time stamp. Six seconds have passed since the fourth time stamp of the fourth frame. At the fifth time stamp, a user has inserted a fourth item (e.g., an endoscope) onto a fourth mounting position of the storage cabinet. Control system 102 receives image data associated with the interior of the storage cabinet and, based at least partly on an image classification machine-learning model, determines that there are four items present and generates a classification of the detected items. At the fifth time stamp, control system 102 asserts a 98% likelihood that the item stored in the fourth position is a “scope”, a 92% likelihood that the item stored in the third position is a “scope”, a 99% likelihood that the item stored in the second position is a “scope”, and a 91% likelihood that the item stored in the first position is a “scope.” The first line of text in the fourth subframe reflects that the number of items detected is 4.

As shown in FIG. 4F, depicted is a sixth frame of the video showing the system at a sixth time stamp. Five seconds have passed since the fifth time stamp of the fifth frame. At the sixth time stamp, a user has removed the second item (e.g., an endoscope) from the second mounting position of the storage cabinet. Control system 102 receives image data associated with the interior of the storage cabinet and, based at least partly on an image classification machine-learning model, determines that there are now only three items present and generates a classification of the detected items. At the sixth time stamp, control system 102 asserts a 99% likelihood that the item stored in the fourth position is a “scope”, a 96% likelihood that the item stored in the third position is a “scope”, and a 94% likelihood that the item stored in the first position is a “scope.” No item is detected at the second position. The first line of text in the fourth subframe reflects that the number of items detected is 3.

As shown in FIG. 4G, depicted is a seventh frame of the video showing the system at a seventh time stamp. Nine seconds have passed since the sixth time stamp of the sixth frame. At the seventh time stamp, a user has removed the fourth item (e.g., an endoscope) from the fourth mounting position of the storage cabinet. Control system 102 receives image data associated with the interior of the storage cabinet and, based at least partly on an image classification machine-learning model, determines that there are now only two items present and generates a classification of the detected items. At the seventh time stamp, control system 102 asserts a 98% likelihood that the item stored in the third position is a “scope”, and a 96% likelihood that the item stored in the first position is a “scope.” No item is detected at the second position or the fourth position. The first line of text in the fourth subframe reflects that the number of items detected is 2.

As shown in FIG. 4H, depicted is an eighth frame of the video showing the system at an eighth time stamp. Four seconds have passed since the seventh time stamp of the seventh frame. At the eighth time stamp, a user has removed the first item (e.g., an endoscope) from the first mounting position of the storage cabinet. Control system 102 receives image data associated with the interior of the storage cabinet and, based at least partly on an image classification machine-learning model, determines that there is now only one item present and generates a classification of the detected item. At the eighth time stamp, control system 102 asserts a 96% likelihood that the item stored in the third position is a “scope”. No item is detected at the first position, second position, or third position. The first line of text in the fourth subframe reflects that the number of items detected is 1.

As shown in FIG. 4I, depicted is a ninth frame of the video showing the system at a ninth time stamp. Seven seconds have passed since the eighth time stamp of the eighth frame. At the ninth time stamp, a user has removed the third item (e.g., an endoscope) from the third mounting position of the storage cabinet. Control system 102 receives image data associated with the interior of the storage cabinet and, based at least partly on an image classification machine-learning model, determines that there are now no items present. No items are detected at any of the positions in the storage cabinet. The first line of text in the fourth subframe reflects that the number of items detected is 0.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method comprising:
receiving, with at least one processor, image data from at least one imaging device, the image data associated with at least one image of at least one item in at least one room of a hospital;
determining, with at least one processor, at least one location of the at least one item based at least partly on at least one position of the at least one imaging device;
inputting, with at least one processor, at least a portion of the image data to at least one image classification machine-learning model, the at least one image classification machine-learning model being trained at least partly on a set of images of items associated with an inventory of the hospital;
determining, with at least one processor, at least one item identifier of the at least one item based on at least one output of the at least one image classification machine-learning model;
determining, with at least one processor, at least one item record associated with the at least one item in at least one database based on the at least one item identifier; and
updating, with at least one processor, the at least one item record in the at least one database, wherein updating the at least one item record comprises:
updating at least one last known location in the at least one item record based on the at least one location of the at least one item.

2. The computer-implemented method of claim 1, wherein the at least one item is a plurality of items in the at least one room of the hospital, and wherein the at least one item record is a plurality of item records, the method further comprising:
determining, with at least one processor, a plurality of locations of the plurality of items based on the plurality of item records; and
generating, with at least one processor, an inventory report of the hospital based on the plurality of items and the plurality of locations.

3. The computer-implemented method of claim 2, wherein determining the at least one item record in the at least one database comprises:
determining that the at least one item record does not yet exist in the at least one database based on the at least one item identifier; and
generating the at least one item record associated with the at least one item.

4. The computer-implemented method of claim 3, wherein generating the at least one item record comprises:
determining at least one expiration date associated with the at least one item; and
updating at least one expiration date field of the at least one item record based on the at least one expiration date.

5. The computer-implemented method of claim 4, wherein the method further comprises:
determining, with at least one processor, a plurality of expiration dates based on the plurality of item records; and
determining, with at least one processor, a total value of the plurality of items based on an individual value of each item of the plurality of items; and
wherein generating the inventory report of the hospital comprises:
generating the inventory report of the hospital based on the plurality of items, the plurality of locations, the plurality of expiration dates, and the total value.

6. The computer-implemented method of claim 4, further comprising:
determining, with at least one processor, at least one expired item based on a current date and the at least one expiration date field of the at least one item record; and
transmitting, with at least one processor, at least one alert to at least one computing device associated with at least one inventory personnel based on the at least one expired item.

7. The computer-implemented method of claim 1, further comprising:
receiving, with at least one processor, a recall notice associated with the at least one item;
determining, with at least one processor, at least one current location of the at least one item based on the at least one item record; and
transmitting, with at least one processor, at least one message to at least one computing device associated with at least one inventory personnel, the at least one message comprising the at least one current location of the at least one item and at least a portion of the recall notice.

8. The computer-implemented method of claim 1, wherein receiving the image data from the at least one imaging device comprises:
receiving the image data from the at least one imaging device on an ongoing basis, wherein the image data comprises a stream of images; and
wherein the method further comprises:
tracking, with at least one processor, the at least one item throughout the at least one room based on the stream of images.

9. The computer-implemented method of claim 8, further comprising:
determining, with at least one processor, at least one identification of at least one human in the at least one room based on the image data;
wherein updating the at least one item record in the at least one database further comprises:
associating the at least one item record with at least one patient identifier or at least one clinician identifier based on the at least one identification of the at least one human.

10. The computer-implemented method of claim 9, wherein the at least one human in the at least one room is at least one patient undergoing at least one operation and at least one clinician performing the at least one operation, the method further comprising:
inputting, with at least one processor, at least a portion of the stream of images into the at least one image classification machine-learning model, the at least one image classification machine-learning model being trained at least partly on a set of images of actions taken in a plurality of patient operations; and
determining, with at least one processor, at least one action of the at least one operation based on at least one second output of the at least one image classification machine-learning model;
wherein updating the at least one item record in the at least one database further comprises:
associating the at least one item record with the at least one patient identifier, the at least one clinician identifier, at least one identifier of the at least one action, and at least one time of the at least one action.

11. A system comprising:
at least one processor configured to:
receive image data from at least one imaging device, the image data associated with at least one image of at least one item in at least one room of a hospital;
determine at least one location of the at least one item based at least partly on at least one position of the at least one imaging device;
input at least a portion of the image data to at least one image classification machine-learning model, the at least one image classification machine-learning model being trained at least partly on a set of images of items associated with an inventory of the hospital;
determine at least one item identifier of the at least one item based on at least one output of the at least one image classification machine-learning model;
determine at least one item record associated with the at least one item in at least one database based on the at least one item identifier; and
update the at least one item record in the at least one database, wherein, when updating the at least one item record, the at least one processor is configured to:
update at least one last known location in the at least one item record based on the at least one location of the at least one item.

12. The system of claim 11, wherein the at least one item is a plurality of items in the at least one room of the hospital, wherein the at least one item record is a plurality of item records, and wherein the at least one processor is further configured to:
determine a plurality of locations of the plurality of items based on the plurality of item records; and
generate an inventory report of the hospital based on the plurality of items and the plurality of locations.

13. The system of claim 12, wherein, when determining the at least one item record in the at least one database, the at least one processor is configured to:
determine that the at least one item record does not yet exist in the at least one database based on the at least one item identifier; and
generate the at least one item record associated with the at least one item.

14. The system of claim 11, wherein, when receiving the image data from the at least one imaging device, the at least one processor is configured to:
receive the image data from the at least one imaging device on an ongoing basis, wherein the image data comprises a stream of images; and
wherein the at least one processor is further configured to:
track the at least one item throughout the at least one room based on the stream of images.

15. The system of claim 14, wherein the at least one processor is further configured to:
determine at least one identification of at least one human in the at least one room based on the image data; and
wherein, when updating the at least one item record in the at least one database, the at least one processor is configured to:
associate the at least one item record with at least one patient identifier or at least one clinician identifier based on the at least one identification of the at least one human.

16. A computer program product comprising at least one non-transitory computer-readable medium comprising program instructions that, when executed by at least one processor, cause the at least one processor to:
receive image data from at least one imaging device, the image data associated with at least one image of at least one item in at least one room of a hospital;
determine at least one location of the at least one item based at least partly on at least one position of the at least one imaging device;
input at least a portion of the image data to at least one image classification machine-learning model, the at least one image classification machine-learning model being trained at least partly on a set of images of items associated with an inventory of the hospital;
determine at least one item identifier of the at least one item based on at least one output of the at least one image classification machine-learning model;
determine at least one item record associated with the at least one item in at least one database based on the at least one item identifier; and
update the at least one item record in the at least one database, wherein the program instructions that cause the at least one processor to update the at least one item record cause the at least one processor to:
update at least one last known location in the at least one item record based on the at least one location of the at least one item.

17. The computer program product of claim 16, wherein the at least one item is a plurality of items in the at least one room of the hospital, wherein the at least one item record is a plurality of item records, and wherein the program instructions further cause the at least at least one processor to:
determine a plurality of locations of the plurality of items based on the plurality of item records; and
generate an inventory report of the hospital based on the plurality of items and the plurality of locations.

18. The computer program product of claim 17, wherein the program instructions that cause the at least one processor to determine the at least one item record in the at least one database cause the at least one processor to:
determine that the at least one item record does not yet exist in the at least one database based on the at least one item identifier; and
generate the at least one item record associated with the at least one item.

19. The computer program product of claim 16, wherein the program instructions that cause the at least one processor to receive the image data from the at least one imaging device cause the at least one processor to:
receive the image data from the at least one imaging device on an ongoing basis, wherein the image data comprises a stream of images; and
wherein the program instructions further cause the at least one processor to:
track the at least one item throughout the at least one room based on the stream of images.

20. The computer program product of claim 19, wherein the program instructions further cause the at least one processor to:
determine at least one identification of at least one human in the at least one room based on the image data; and
wherein the program instructions that cause the at least one processor to update the at least one item record in the at least one database cause the at least one processor to:
associate the at least one item record with at least one patient identifier or at least one clinician identifier based on the at least one identification of the at least one human.
